(19) United States
(12) Patent Application Publication
(10) Pub. No.: US 2005/0181104 A1
(43) Pub. Date: Aug. 18, 2005

(54) Frozen food retaining charcoal-grilled flavor and method for producing same

(75) Inventors: Hikaru Shibata, Kawasaki-shi (JP); Makoto Tanabe, Kawasaki-shi (JP); Shundo Harada, Kawasaki-shi (JP); Kazunari Oomachi, Oura-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO., INC, Kawasaki-shi (JP)

(21) Appl. No.: 11/035,722

(22) Filed: Jan. 18, 2005

Related U.S. Application Data
(63) Continuation of application No. PCT/JP03/08324, filed on Jun. 30, 2003.

(30) Foreign Application Priority Data
Jul. 16, 2002 (JP) 2002-206488

(51) Int. Cl. A23C 3/00

(52) U.S. Cl. 426/524

(57) ABSTRACT

A method for producing a frozen food includes heating food, such as by grilling. The food is dipped in a sauce to provide a flavored sauce, such as a charcoal-flavored sauce. The food is preferably dipped in the sauce from one to ten times. The food is preferably packaged with the flavored sauce, and is steamed. Preferably, the food is steamed with the sauce at a temperature from 80 to 105° C. for a time interval from 3 to 60 minutes. The previously steamed food is frozen.

### BACKGROUND OF THE INVENTION

1. Field of the Invention

The present invention relates to a frozen food retaining charcoal-grilled flavor, as well as a method for producing the frozen food.

2. Discussion of the Related Art

A known method for providing charcoal-grilled flavor to foods includes a method for producing an aromatic composition, in which a raw material is heated in an oxygen-existing atmosphere so that at least a part of the raw material is scorched and captures the generated aromatic components in a capture liquid, as disclosed in JP-A-8-291298. Another known method includes contacting oils and fats or fatty acid to a carbon material with a surface temperature from 100 to 1,000° C., and recovering a generated gas or liquid generated together with the gas, as disclosed in JP-A-2000-8073.

These methods are directed to producing aromatic compositions and flavor, however, and only disclose that appropriate amounts of the aromatic compositions and the flavors are added to foods to which the flavors are to be given. Therefore, these methods do not address long-term characteristics of the flavors given to foods. Further, these methods for adding the aromatic composition or the flavors to foods have a tendency to generate enhanced odor. It is also difficult to obtain natural flavors with these methods.

Another known method of flavoring Japanese style grilled chicken or grilled chicken-like foods includes heating poultry meat impregnated with sauce containing sugar and paste-like poultry skin to enhance the flavor, filling and sealing the resulting poultry meat in can for retorting under heating, and subsequently cooling the can to prepare a canned food, as disclosed in JP-A-61-219356). This method can retain the resulting flavor for a long period of time.

However, food texture (e.g., the quality of the meat) is modified via retorting under heating at a high temperature. Further, although after retorting the canned food can be stored in canned form at room temperature for a long period of time, the canned food does not satisfactorily retain its flavor.

### SUMMARY OF THE INVENTION

It is an object of the invention to provide a method for producing a frozen food retaining charcoal-grilled flavor for a long period of time, as well as a frozen food produced by the method.

The inventors of the present invention that the above disadvantages provided by known methods can be overcome by preparing a sauce, grilling livestock meat food on charcoal, dipping the meat in the sauce from one to 10 times to provide charcoal-grilled flavor to the sauce, packing the resulting sauce with the grilled food, steaming the food in atmosphere at a temperature from 80 to 105° C. for a time period from 3 to 60 minutes, and freezing the food.

The present invention can provide a method for producing a frozen food that includes heating food, such as by grilling. The food is dipped in a sauce to provide a flavored sauce, such as a charcoal-flavored sauce. The food is preferably dipped in the sauce from one to ten times. The food is preferably packaged with the flavored sauce, and is steamed. Preferably, the food is steamed with the sauce at a temperature from 80 to 105° C. for a time interval from 3 to 60 minutes. The previously steamed food is frozen.

### DETAILED DESCRIPTION

The invention includes packing a grilled food together with a sauce having charcoal-grilled flavor prepared by dipping a charcoal-grilled livestock meat food in the sauce from one to 10 times, then steaming the food in atmosphere at a temperature from about 80 to about 105° C. for a time period from about 3 to about 60 minutes, and freezing the food. By steaming and freezing, the frozen food obtains a flavor that is not provided by simply mixing foods with conventional sauces.

It is believed by the inventors that as a result of the specified steaming and freezing, components providing the charcoal-grilled flavor, as well as liquid ingredients and the like in the sauce, significantly permeate to the interior of the food. Thus, a strong charcoal flavor is perceived when the food is ingested. Known methods of flavoring foods, which include flavored sauces, provide unnatural strong flavors only to the surface of the food, and do not provide flavor to the interior of the food.

In the present invention, because the sauce can permeate into the interior of the food, desirable smells and flavors can be diffused throughout the food, and natural aromas and flavors can be obtained.

Charcoal-grilled flavor is provided by a combination of many components. In a method in which a charcoal-grilled flavor is concentrated or extracted, the amounts of the components may be modified. In contrast, because the present invention includes the sauce that receives the charcoal-grilled flavor without concentration or extraction, a natural flavor can be obtained, as well as the natural aroma provided by charcoal-grilling.

In accordance with the invention, freezing can retain the charcoal-grilled flavor for a long period of time.

In accordance with the invention, the food preferably includes, but is not limited to, livestock meat foods such as Japanese style grilled chicken (yakitori), pure white and fluffy fish cake (hanpen) and rice ball (onigiri).

For packing in accordance with the invention, any material for use in food packing having the ability to endure steaming and freezing can be used. Preferably, the food is vacuum packed, because vacuum packing holds the sauce in contact with the food, such that the sauce can readily permeate into the food.

In accordance with the present invention, the food can be steaming in atmosphere for a time interval from about 3 to about 60 minutes, at a temperature from about 80 to about 105° C. The time interval and temperature can be determined such that the food is sterilized (e.g., such that a temperature of the interior of the food can be at least about 75° C.). Under other conditions, the texture of the resulting food may deteriorate, and/or the food may not be completely sterilized. Preferably, the food is heated in boiling water and steam-heated by a convection oven.

In accordance with the present invention, the food can be frozen after steaming, such as by rapid freezing or low-temperature storage, to suppress deterioration of the quality of the sauce having charcoal-grilled flavor and the food, as well as to suppress water transfer. Preferably, rapid freezing is done at a temperature of −50° C. or less within one hour. Further, a core temperature of the food after freezing is preferably −5° C. or less, and more preferably is −18° C. or less.

The sauce of the present invention can include, but is not limited to, soy sauce, umami seasoning, oligosaccharides such as sucrose and lactose, or monosaccharides such as glucose and fructose. In accordance with the present invention, the sauces can include agents affecting the viscosity of the sauce, such as starches (potato starch and cornstarch) and gelling agents.

In accordance with the present invention, the sauce having charcoal-grilled flavor can be prepared by grilling livestock meat food on charcoal, and subsequently dipping the livestock meat food in a sauce from one to 10 times. In such manner, fats from the livestock meat food and the sauce contact the charcoal fire, to generate charcoal-grilled flavor, which adheres to the livestock meat food and the sauce coated on the livestock meat food. By dipping again the livestock meat food in a large volume of the sauce, the charcoal-grilled flavor adhering to the livestock meat food and the sauce coated on the livestock meat food is transferred to the large volume of the sauce, so that the large volume of the sauce receives the aromatic charcoal-grilled flavor.

In accordance with the present invention, the livestock meat food can include livestock meat such as chicken meat, pork and beef, and can also include livestock meat-processed foods such as ham, sausage, bacon, minced chicken and ground beef (e.g., hamburger) prepared from livestock meat. Preferably, the livestock meat food includes livestock meat. However, the characteristics of the livestock meat food can be determined to satisfy a variety of factors, such as cost and production method.

The livestock meat food can be heated by a variety of methods. Examples of heating methods include a gas range, electric range, solid fuel stove, firewood, charcoal, far infrared ray and the like. Preferably, the food is heated by generating far infrared ray, such as with charcoal. By heating with charcoal, in particular, the food texture of grilled livestock meat food is softened. Additionally, charcoal-grilled flavor is directly given to the livestock meat food. Therefore, grilling provides the food with an aromatic charcoal-flavor.

Preferably, fats and oils are coated on livestock meat food to enhance the flavor. The fats and oils can include any edible fats and oils, such as animal fats and oils (chicken fats and oils, pork fats and oils, and vegetable oils such as salad oil and corn oil). Preferably, animal fats and oils, and more preferable, chicken fats and oils are used, in view of cost as well as taste and flavor.

The grilled food is preferably dipped into the sauce from one to ten times, and more preferably is dipped into the sauce from two to 5 times, such that the sauce does not receive either too weak or too strong of a charcoal-grilled flavor. Preferably, the weight of the livestock meat food is from about two to 10 times the weight of the sauce, and more preferably is from about three to about 6 times the weight of the sauce.

The sauce receives the charcoal-grilled flavor. Thus, in accordance with the present invention, the charcoal-grilled flavor and the liquid ingredients of the sauce can significantly permeate into the interior of the food through steaming and subsequent freezing, so that a strong, natural, and desirable charcoal flavor and aroma is diffused through the food, which can be perceived during ingestion of the food.

### EXAMPLES

Examples of the invention are now described. It is to be understood, however, that the invention is not limited to these examples.

Preparation of Standard Product

After chicken meat was dipped in the sauce of the composition in Table 1 for 15 minutes, the chicken meat was grilled on charcoal such that a temperature of the atmosphere was from 280 to 320° C., until the core temperature of the chicken meat was from 70 to 75° C. (i). Then, 100 g of the grilled chicken meat and 25 g of the sauce of the composition in Table 1 were placed in an aluminum-pouch packing container, which was then sealed in vacuum with a vacuum packer (AUTO VACUUM PACKER V-304G, TOSEI CO., LTD.) (ii). Subsequently, the vacuum-packed meat was steamed in a convection oven (GSC-30B, TANICO Corporation) at 95° C. for 10 minutes (iii).

TABLE 1
The composition of the sauce is as follows.

| | |
|---|---|
| Soy sauce (koikuchi shoyu) | 15.0 |
| Fructose glucose | 21.1 |
| Sugar | 15.0 |
| Water | 43.7 |
| Sodium glutamate | 1.7 |
| Sodium chloride (edible) | 1.1 |
| Caramel | 0.3 |
| Cornstarch | 0.5 |
| Vinegar | 1.5 |
| Total | 100.0 |

### EXAMPLE 1

Twenty five grams of the sauce having charcoal-grilled flavor were used in place of 25 g of the sauce of the composition shown in Table 1 in the production step (ii) for the standard product. The food was frozen at a temperature of −50° C. for one hour, after the production step (iii) for the standard product. The resulting product was then stored frozen for 3 months.

The sauce having charcoal-grilled flavor as used in the Examples and Comparative Examples was prepared as follows. Specifically, both the surfaces of chicken meat cut in one-bite pieces (about 5 g) were grilled on charcoal such that the temperature of the atmosphere was from 280 to 320° C., until the core temperature of the chicken meat was from 70 to 75° C. Subsequently, the grilled chicken meat was dipped in the sauce of the composition in Table 1. Then, the food was again grilled, and was again dipped into the sauce. This was repeated, until a ratio of the weight of chicken meat to the weight of the sauce was four to 1.

### COMPARATIVE EXAMPLE 1

After the production step (iii) for the standard product, the food was frozen at a temperature of −50° C. for one hour. The resulting product was stored frozen for 3 months.

### COMPARATIVE EXAMPLE 2

Twenty five grams of the sauce having charcoal-grilled flavor was used in place of the 25 g of the sauce of the composition shown in Table 1 in the production step (ii) for the standard product. The food was retorted under heating at a temperature of 116° C. for 45 minutes, after the production step (ii) for the standard product.

### COMPARATIVE EXAMPLE 3

Twenty five grams of the sauce having charcoal-grilled flavor was used in place of 25 g of the sauce of the composition shown in Table 1 in the production step (ii) for the standard product. The food was retorted under heating at a temperature of 116° C. for 45 minutes, after the production step (ii) for the standard product. Then, the resulting product was stored at a temperature of −5° C. for 2 weeks.

The frozen products of Example 1 and Comparative Example 1 were boiled for 10 minutes to return the products to edible states for sensory evaluation. By the retorting and heating, the food product of Comparative Example 2 was returned to an edible state. Comparative Example 3 was boiled for 5 minutes to return the product to an edible state for sensory evaluation. The sensory evaluation was done by a scoring method (n=5). Concerning scores, the standard product was ranked at score 0. The highest score was 5, while the lowest score was −5.

As the standards for individual items to be evaluated, the item “intensity” is ranked from the score 5 for “highly intense” to the score −5 for “very weak”. The item “preference” is ranked from 5 for “very preferable” to −5 for “very unpreferable”. The item “general evaluation” for “smell” and “flavor” in combination is ranked from 5 for “very preferable” to −5 for “very unpreferable”.

The results of the sensory evaluation are shown in Table 2.

TABLE 2

| | | Comparative | Comparative | Comparative |
|---|---|---|---|---|
| | Example 1 | Example 1 | Example 2 | Example 3 |
| Intensity of | 0.3 | −0.6 | 0.4 | −1.0 |
| charcoal-grilled | | | | |
| flavor | | | | |
| Preference of | 0.2 | −0.4 | −2.4 | −2.6 |
| charcoal-grilled | | | | |
| flavor | | | | |
| Intensity of | −0.8 | −0.6 | 0.6 | −0.8 |
| charcoal smell | | | | |
| General | 0.2 | −0.8 | −2.4 | −3.4 |
| evaluation | | | | |

From the results in Table 2, it was verified that Example 1 using the invention was superior to the standard product according to the general evaluation, even though Example 1 of the invention was stored for 3 months. Comparative Example 2 produced by using the sauce given charcoal-grilled flavor but through retorting under heating had more intense charcoal-grilled flavor and charcoal smell than those of the standard product. Even without the storage step, however, the charcoal-grilled flavor was not preferable. It was confirmed that simple use of the sauce given charcoal-grilled flavor could not produce the effect of the invention.

### INDUSTRIAL APPLICABILITY

In accordance with the invention, natural charcoal-grilled flavor can be produced so that enhanced genuine charcoal-grilled flavor can be obtained. Thus, a food retaining the charcoal-grilled flavor for a long period of time can readily be obtained.

1. A method for producing a frozen food, comprising:
heating food;
dipping the previously heated food in a sauce to provide a flavored sauce;
steaming the food with the flavored sauce; and
freezing the previously steamed food.

2. The method according to claim 1, wherein heating comprises grilling the food.

3. The method according to claim 2, wherein dipping provides a grilled-flavored sauce.

4. The method according to claim 3, wherein heating comprises charcoal-grilling the food.

5. The method according to claim 4, wherein dipping provides a charcoal-flavor sauce.

6. The method according to claim 1, wherein steaming comprises steaming at a temperature from 80 to 105° C.

7. The method according to claim 1, wherein steaming comprises steaming for a time interval from 3 to 60 minutes.

8. The method according to claim 7, wherein steaming comprises steaming at a temperature from 80 to 105° C.

9. The method according to claim 1, wherein dipping comprises dipping the heated food in the sauce from one to ten times.

10. The method according to claim 9, wherein steaming comprises steaming at a temperature from 80 to 105° C. for a time interval from 3 to 60 minutes.

11. The method according to claim 10, where the food comprises livestock.

12. The method according to claim 11, wherein the livestock comprises processed livestock food.

13. The method according to claim 1, wherein dipping provides a charcoal-flavored sauce.

14. The method according to claim 13, wherein dipping comprises dipping between one and ten times.

15. The method according to claim 14, wherein steaming comprises steaming at a temperature from 80 to 105° C. for a time interval from 3 to 60 minutes.

16. A frozen food produced by the method according to claim 1.
